(19) United States
(12) Patent Application Publication
(10) Pub. No.: US 2021/0018263 A1
(43) Pub. Date: Jan. 21, 2021

(54) Cannabis Freeze Drying Machine

(71) Applicants: Danyelle Elaine Sheridan, Howell, MI (US); Jolene Laho, New Boston, MI (US)

(72) Inventors: Danyelle Elaine Sheridan, Howell, MI (US); Jolene Laho, New Boston, MI (US)

(21) Appl. No.: 16/932,057

(22) Filed: Jul. 17, 2020

Related U.S. Application Data
(60) Provisional application No. 62/876,266, filed on Jul. 19, 2019.

(51) Int. Cl. F26B 5/06

(52) U.S. Cl. CPC F26B 5/06; F26B 2200/00

(57) ABSTRACT

The present invention is a freeze dryer that contains attachments, accessories, and equipment to assist cannabis cultivators in the drying and curing process of their cannabis produce. The present invention comprises a flexible filter assembly surrounding a vacuum release valve, that helps filter out any pollutants or harmful substances from reaching the cannabis produce. Further, the present invention eliminates the need to periodically remove the cannabis produce for inspection, by attaching moisture probes, temperature sensors, weight scales, and cannabis analyzer within the freeze dryer, and integrating the values obtained from these equipment into a display panel on the freeze dryer. Furthermore, the present invention includes a blackout panel for maintaining darkness inside the specimen chamber, as well as a collapsible worktable for additional utility. Additionally, the present invention eliminates the problem of involving too many separate components, by combining these components and equipment into a single freeze dryer.

The current application claims a priority to the U.S. Provisional Patent application Ser. No. 62/876,266 filed on Jul. 19, 2019.

### FIELD OF THE INVENTION

The present invention relates generally to apparatuses for preserving organic products. Specifically, the present invention is a freeze dryer with specific attachments and accessories/equipment for drying and curing plant products and/or produce from cannabis plants.

### BACKGROUND OF THE INVENTION

In today's society, there is a growing trend in the United States to legalize marijuana and other similar drugs, which leads to the legalization of cannabis plants. A method of cultivating marijuana from cannabis plants is to utilize the flowers from cannabis plants. A method of cultivating hemp from the cannabis is by utilizing the stem from cannabis plants. Therefore, cannabis cultivators tend to utilize both the flower and the stem from the cannabis plants when they are ready to be cultivated by cutting the stem, with the flower attached, from the cannabis plant. The stem is kept with the flower because the stem helps to stabilize the flower as it is drying. After cutting the flower and stem from the cannabis plant, cultivators hang-dry the flower because they are too moist to be potent as a drug and to be useable cannabis that are ready for curing. The drying and curing process of cultivating the flower from cannabis plants is a very precise process. In order to properly cultivate products from cannabis plant, cultivators usually slow-dry their plants under very strict and heavily controlled environmental conditions. The drying process can be done faster, but a faster drying process could result in poorer products for cultivation. It is preferred that the plant and stem from cannabis have a moisture level between 5-15% in order for it to be considered dry and ready for the curing process. The most preferred environmental condition for cultivating cannabis plant is a dark and dry environment with humidity levels between 45%-55% and temperatures ranging from 60-70° F. If the drying process is too fast, the drugs produced from cannabis plants become very poor in quality. Such poor quality can include smelling and tasting terrible and giving cannabis users migraines and paranoia after drug use. Additionally, if the humidity level is too high or the temperature level is too low, mold can begin to set in the cannabis produce, which makes the product toxic and unusable. On the other hand, if the humidity level is too low or the temperature is too high, the cannabis produce can become burnt and end-up drying too fast before proper curing can take place. The specific conditions for cultivating marijuana from cannabis plants requires cannabis cultivators to utilize makeshift dark rooms that replicates those conditions. However, this method requires cannabis cultivators to utilize a plethora of equipment that are cumbersome to use, not ergonomically spacious, and expensive. Equipment required to control the environment includes air conditioners, evaporative cooler, dehumidifier, heater, fans, blackout curtains, and cannabis analyzers. Additionally, cannabis cultivators often must use growing tents to hang their cannabis produce, which can take up more space in the cannabis cultivator's home or warehouse. The added space also is required to help circulate the air. Without adhering to the strict environmental conditions for curing the cannabis flower, cultivators can find that their product will not have the potency required to be effective for either recreational or medical use. Potency is the efficacy of a product to give a user a feeling of “high”, or relief from pain. Potency is based on the chemical composition of the final product, with different compositions being used for different purposes. Potency is also affected by the amount darkness and heat received by the plant product. Some chemical compounds are more volatile because they evaporate at lower temperature levels than water does. Chemical composition is relative to the type of the cannabis plant being used and the how long the drying and curing process occurred. Another issue of the current means for drying and curing cannabis flowers is the process of measuring the attributes of the cannabis flowers. The current means requires cannabis cultivators to remove the cannabis flowers from their dark room environment into a lighted area to be examined temporally for weight, chemical composition, and moisture content. This repeated removal of the cannabis flower for examination can have detrimental effects on the final product by leaving the cannabis cultivator with a product that does not match the desired potency they require. Or, if the potency desired is met, most often it is met by a prolonged drying and curing process. In today's consumer economy, the faster a supplier can release their product, the more returns they can expect.

An objective of the present invention is to provide a single apparatus for drying and curing cannabis produce by means of freeze-drying. Freeze-drying cannabis produce preserves the terpenes at higher rates than the conventional means of air drying the cannabis produce. There have existed freeze-drying apparatuses that have been documented for use with drying and curing cannabis produce. Majority of these freeze-drying apparatuses do not employ a vacuum, instead relying on a combination of a fan and dry ice. This is not ideal, since dry ice needs to be continuously restocked, and a fan can add undesired air circulation, which can reduce the rate of preservation of terpenes. Meanwhile, most other apparatuses include a freeze dryer. However, these freeze dryers do not include all the necessary components needed to obtain and maintain the environmental conditions required for drying and curing cannabis produce. Also, conventional freeze dryers do not have the added components for monitoring the cannabis produce as it is drying and curing, nor do they have additional components that make the freeze dryer unique for the curing and drying of cannabis produce. The present invention seeks to overcome issues of ergonomic, ease of use, and cost by providing cannabis cultivators with a single apparatus for drying and curing their cannabis produce and monitoring and controlling the environmental conditions of their cannabis produce. The present invention is a freeze dryer that contains attachments, accessories, and equipment to assist cannabis cultivators in the drying and curing process of their cannabis produce. Such attachments, accessories, and equipment can include: environmental sensors and probes for monitoring the temperature and humidity of the freeze dryer chamber, a filter assembly surrounding a vacuum release valve, attached fold-out table, blackout panel with a writable surface, and external compartments for storage. Humidity of chamber is monitored because air is released back into the chamber after the freeze-drying process is completed. By combining these components into one apparatus, the present invention can assist cannabis cultivators in saving money by providing them a single piece of equipment that can monitor and control their cannabis produce's environmental conditions during the drying and curing process. Likewise, the present invention makes it easier and less confusing for cannabis cultivator to monitor and control the cannabis produce environmental conditions by providing a single apparatus, as oppose to multiple different equipment for monitor and control environmental conditions. Also, the present invention allows cannabis cultivators to control the amount of active/potent ingredients found in their products by controlling the environmental conditions that influence the drying and curing process, which affect the potency or chemical composition of the final product. The present invention is more ergonomic in space efficiency by providing cannabis cultivators with a single apparatus that can be easily stored away without the need to set up a growing tent or makeshift dark rooms. Finally, the present invention assists cannabis cultivators in controlling the potency of their product by eliminating the need to remove the cannabis produce for inspection periodically because the present invention contains multiple sensors and probes that monitor the attributes of the cannabis produce, and provide this information to the cannabis cultivators externally via a display panel on the outside of the freeze dryer.

### BRIEF DESCRIPTION OF THE DRAWINGS

FIG. 1 is a block diagram present invention, wherein dashed flowlines represents fluid communication between components.

FIG. 2 is a top-front-left perspective view of a filter assembly, according to a preferred embodiment of the present invention.

FIG. 3 is an exploded front perspective view of the filter assembly.

FIG. 4 is an exploded bottom-rear-right perspective view of the filter assembly.

FIG. 5 is a top-front-left perspective view of the present invention, wherein a black out panel is positioned covering a glass window of the specimen chamber, and wherein a collapsible side table is attached in a workable configuration.

FIG. 6 is a bottom-front-left perspective view of the present invention in FIG. 5.

FIG. 7 is a top-front-left perspective view of the present invention, wherein the blackout panel is positioned away from the glass window, and wherein the collapsible side table is in a collapsed configuration.

FIG. 8 is a top-front-left perspective view of a collection vessel, according to a preferred embodiment of the present invention.

FIG. 9 is a top plane view of the collection vessel in FIG. 8.

FIG. 10 is a block diagram of the present invention, wherein thinner flowlines represent electrical connections between components, and thicker flowlines represent electronic connections between components.

### DETAIL DESCRIPTIONS OF THE INVENTION

All illustrations of the drawings are for the purpose of describing selected versions of the present invention and are not intended to limit the scope of the present invention. In the context of the detailed description of the invention below, all mentions of a user, or users, refer to a single, or multiple, cannabis cultivator, who would use the present invention to freeze dry the cannabis. Additionally, all references of cannabis produce can refer to cannabis flower, cannabis stem, other plant products of the cannabis plant, or any combination of the three.

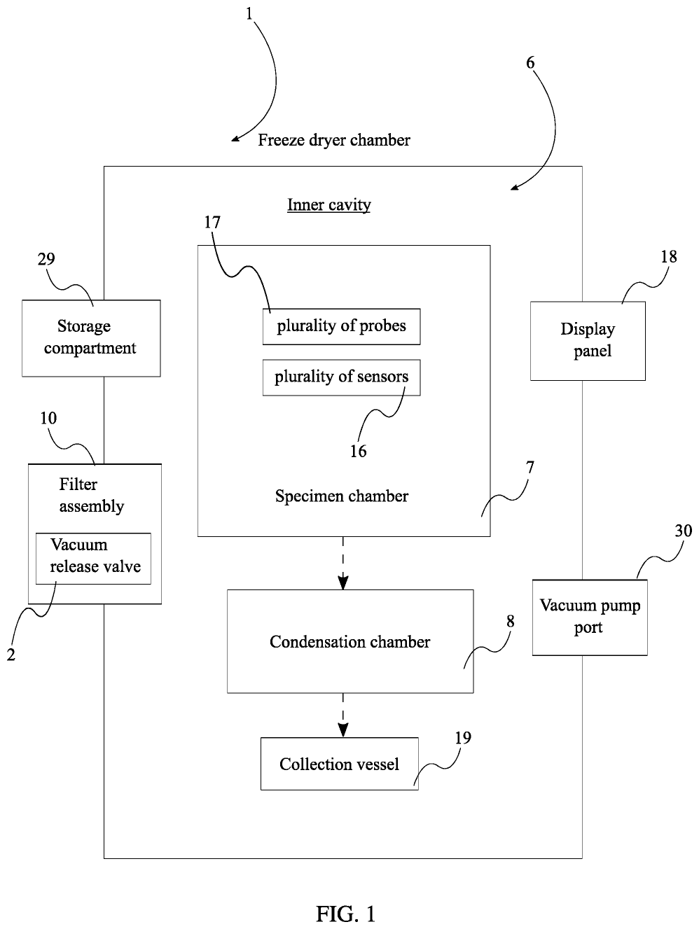

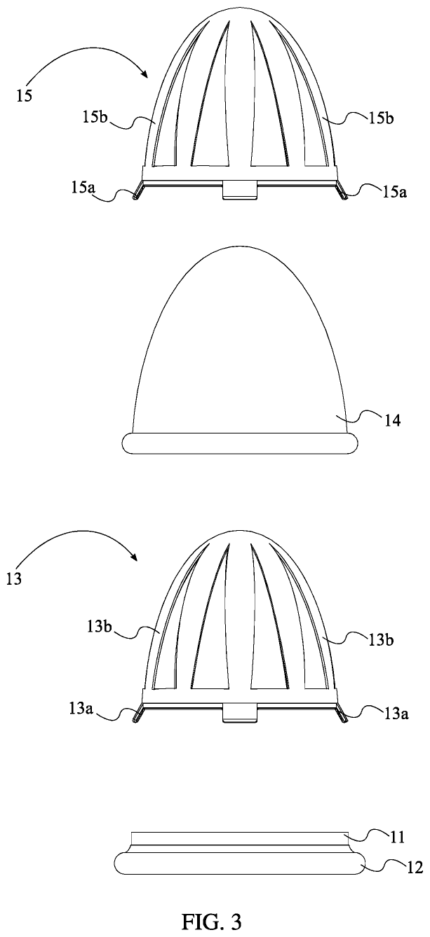

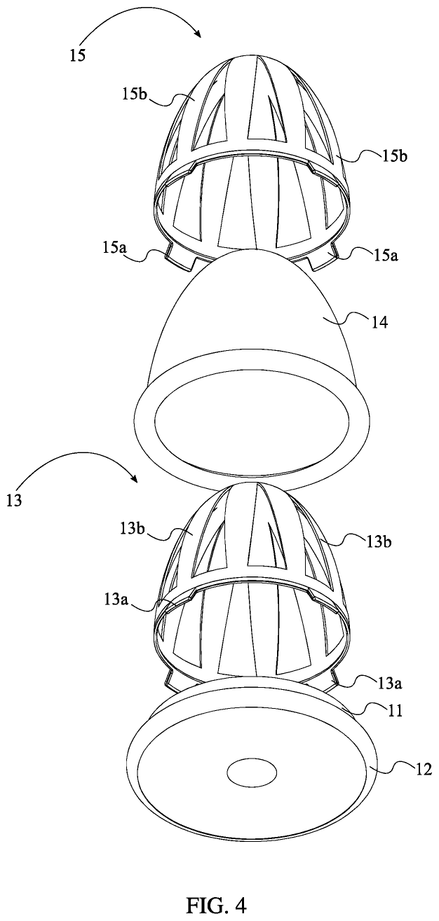

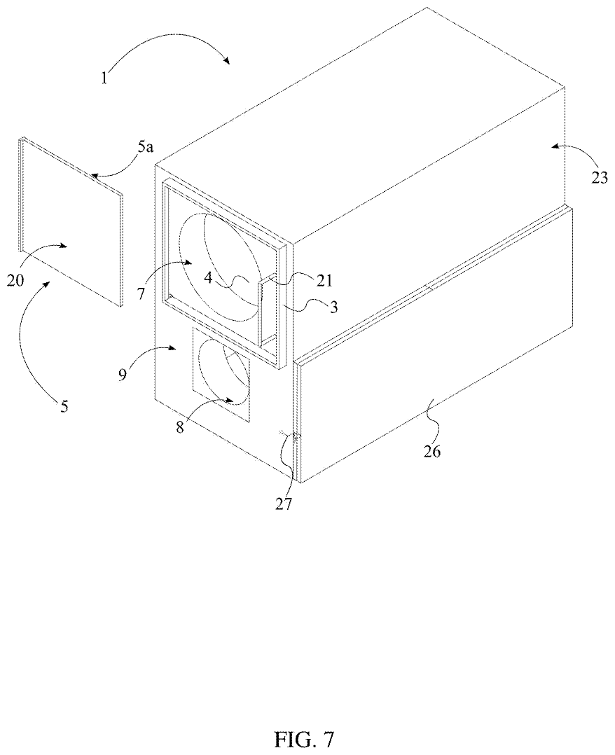

In reference to FIG. 1 through FIG. 10, the present invention is a freeze drying machine. Freeze dryers are normally employed in the preservation of perishable material. They operate by rapidly freezing the perishable material. Once frozen, all ice content can be removed by sublimation, which is conducted by subjecting the frozen perishable material to a high vacuum to decrease its pressure without increasing its temperature. Sublimation is a phase transition of a material going directly from its solid state to its gaseous state without ever entering its liquid state. In the case of freeze dryers, the water contents of the perishable material undergo sublimation to eliminate water content to extend the longevity of the perishable material. In the case of drying and curing cannabis produce that are ripe, cannabis produce is loaded with moisture content that needs to be dried out before curing process can take place. It is an aim of the present invention to shorten, and make more precise, the drying and curing process by using the freeze-drying method to rapidly bring the moisture content of the cannabis produce to a desired level, without having to periodically remove the cannabis produce for inspection. Accordingly, the present invention is a freeze dryer that contains attachments, accessories, and equipment to assist cannabis cultivators in the drying and curing process of their cannabis produce. Such attachments, accessories, and equipment can include: environmental sensors and probes for monitoring the temperature and humidity of the freeze dryer chamber, a filter assembly surrounding a vacuum release valve, attached fold-out table, blackout panel with a writable surface, and external compartments for storage. Further, the present invention eliminates the need to periodically remove the cannabis produce for inspection by attaching moisture probes, temperature sensors, weight scales, and cannabis analyzer within the freeze dryer and integrating the values obtained from these equipment into a display panel on the freeze dryer. Additionally, the present invention eliminates the problem of involving too many separate components, by combining these components and equipment into a single freeze dryer.

The following description is in reference to FIG. 1 through FIG. 10. As seen in FIG. 1 through FIG. 10, the present invention comprises a freeze dryer chamber 1, a vacuum release valve 2, a front door 3, a glass window 4, and a blackout panel 5. In the preferred embodiment, the freeze dryer chamber has a rectangular box shape. However, the freeze dryer chamber 1 may comprise any other shape, size, orientation, components and orientation of components, as long as the intentions of the present invention is not hindered. According to the preferred embodiment of the present invention, the freeze dryer chamber 1 comprises an inner cavity 6, a specimen chamber 7 and a condensation chamber 8. The inner cavity 6 traverses through a front surface 9 of the freeze dryer chamber 1, and the specimen chamber 7 and the condensation chamber 8 are mounted within the inner cavity 6 of the freeze dry chamber 1. This arrangement helps in fulfilling the intent of combining all components and equipment into a single freeze dryer machine. Further, the condensation chamber 8 is laterally mounted onto the specimen chamber 7. Both the specimen chamber 7 and the condensation chamber 8 can comprise any material that is durable, stiff, and strong enough to withstand the conditions of the freeze-drying process. Preferably, the specimen chamber 7 is made of a metal. Further, it should be noted that the specimen chamber 7 and the condensation chamber 8 may be positioned in any other orientation or manner that is known to one of ordinary skill in the art, as long as the objectives of the present invention is not compromised.

Continuing with the preferred embodiment of the present invention, the vacuum release valve 2 is integrated onto an external surface of the freeze dryer chamber 1, and is operably coupled to the inner cavity 6, such that the vacuum release valve 2 can be opened or closed to adjust the pressure within the inner cavity 6. In other words, operating the vacuum release valve 2 enables to operate the passage of air into the inner cavity 6. Preferably, the vacuum release valve 2 is a rotatable knob, however any other valve mechanism that is known to one of ordinary skill in the art may be employed for the vacuum release valve 2. According to the preferred embodiment of the present invention, the front door 3 is hingedly mounted over an opening of the inner cavity 6, and the glass window 4 is laterally integrated onto the front door 3 and positioned adjacent to the inner cavity 6. This is so that the front door 3 enables an operable access to the inner cavity 6, and the glass window 4 functions as an observation tool on the front of the freeze dryer chamber 1. Preferably, the front door 3 comprises the same material as the freeze dryer chamber 1 and works as an access to the specimen chamber 7. However, the front door 3 may comprise any other material that may withstand the temperature and pressure conditions of the present invention. Further, the blackout panel 5 is removably attached to the front door 3, such that the blackout panel 5 may be removed when a user needs to peek inside the specimen chamber 7, through the glass window 4. Preferably, the blackout panel 5 is positioned adjacent the glass window 4, opposite to the specimen chamber 7. Thus, the blackout panel 5 enables in keeping the specimen chamber 7 in darkness even though the front door 3 has a glass window 4. The blackout panel 5 is important because, the most preferred environmental condition for cultivating cannabis plant is a dark and dry environment, and potency is also affected by the amount of darkness received by the plant product. Preferably, the blackout panel 5 can be, at a minimum, the same dimensions of the glass window 4. However, the dimensions of the blackout panel 5 may be greater than the dimensions of the front door 3. Further, any means of attaching the blackout panel 5 to the front door 3 is acceptable as long as there is no light creeping into the specimen chamber 7 through the glass window 4. Such attaching means include, but are not limited to, hook-and-loop fasteners, adhesives, snap clips etc.

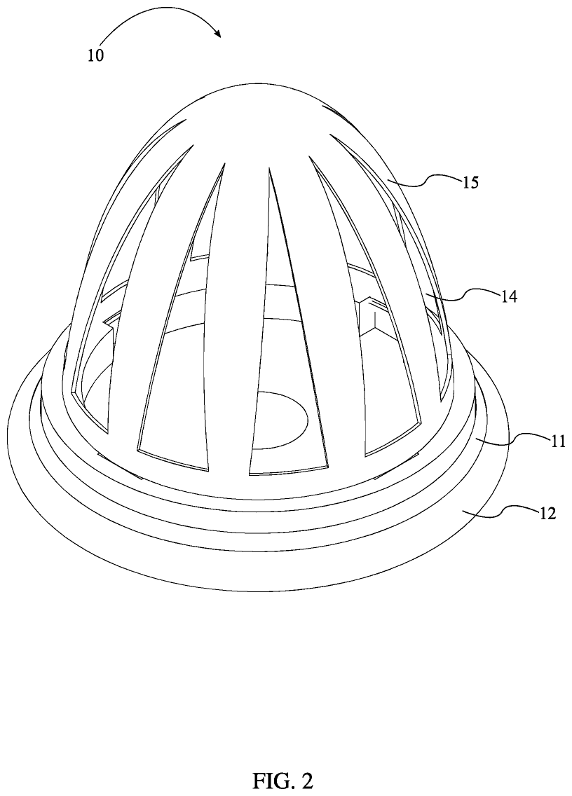

As seen in FIG. 2 through FIG. 4, the present invention comprises a filter assembly 10. The filter assembly 10 further comprises a filter base 11, a rubber seal 12, a filter support 13, an air filter 14, and a filter cover 15. According to the preferred embodiment, the filter base 11 is mounted onto the external surface of the freeze dryer chamber 1, encompassing the vacuum release valve 2. In other words, the filter base 11 rests above and surrounds the vacuum release valve 2. This is so that, the filter assembly 10 prevents any pollutants or harmful substances from reaching the cannabis produce specimens within the freeze dryer chamber through the vacuum release valve 2. Preferably, the rubber seal 12 is integrated onto the filter base 11. This is so that, by encompassing the air filter base 11, the rubber seal 12 ensures that no unwanted air enters through the vacuum release valve 2 in the freeze dryer chamber. Further, the filter support 13 and the filter cover 15 are removably fastened to the filter base 11, and the air filter 14 is positioned between the filter support 14 and the filter cover 15. As seen in FIG. 2 through FIG. 4, the filter base 11 contains slot-like locking mechanism which allows the filter cover 14 to fit and lock into the filter base 11. Within the slot-like locking mechanism, there is a coating of friction material that ensures that the filter support 13 and filter cover 14 are reasonably locked into the filter base 11 without interference from a user. As seen in FIG. 2 through FIG. 4, the filter cover 15 and the filter support 13 contain a plurality of protrusions 15a and 13a respectively, that extend from their base, which is inserted into the slot-like locking mechanism of the filter base 11. Further, the air filter 14 is lodged between the filter support 13 and the filter cover 15, such that the air filter 14 is mechanically supported by the filter support 13 and filter cover 15 from opposing sides. Furthermore, the filter assembly 10 is rotatably coupled to the vacuum release valve 2, wherein rotating the filter assembly 10 along with the vacuum release valve 2, permits opening and closing of the vacuum release valve 2. In order to accomplish rotation of the filter assembly 10 and allowing access to the vacuum release valve 2 through the filter assembly 10, the filter cover 15, the air filter 14, and the filter support 13 are made flexible. In other words, a flexible material is used for these components so that the user may grip the combined air filter 14, the filter cover 15, and the filter support 13, flex it, and turn the vacuum release valve 2 (that is underneath the filter assembly 10), to let air back into the freeze dryer chamber. The air filter 14 can be of any filter material that allows the component to filter out any pollutants or harmful substances from reaching the cannabis produce specimens within the freeze dryer chamber 1. Further, the air filter 14 can be removed from the filter assembly 10 and replaced with a fresh air filter, as the air filter 14 gets old and dirty. Furthermore, the filter cover 15 and the filter support 13 contain rib-like structures 15b and 13b respectively, that allow the user to grip on to the vacuum release valve 2 and allow the air to flow through the filter assembly 10.

It is an aim of the present invention to assist cannabis cultivators in controlling the potency of their product by eliminating the need to remove the cannabis produce for inspection periodically. In order to accomplish that, the present invention comprises a plurality of sensors 16 and a plurality of probes 17, wherein the plurality of sensors 16 and the plurality of probes 17 are mounted within the freeze dryer chamber 1. The sensors and the probes measure the properties of the chamber environment and the cannabis produce specimen while they are in specimen chamber 7. Examples of environmental and specimen parameters the probes 17 and sensors 16 may monitor include, but are not limited to moisture, humidity, temperature etc. However, the sensors and/or probes maybe designed to monitor any other feature that is known to one of ordinary skill in the art. The temperature and humidity sensors monitor the environmental condition of the chamber, and hence the plurality of sensors 16 are preferably mounted along the inner walls of the specimen chamber 7. The plurality of probes 17 exists to monitor the moisture, the potency, or composition, of the cannabis produce specimens within the specimen chamber 7. Accordingly, the plurality of probes 17 is attached to the cannabis produce specimen via any means of penetration, such as a toothed clip or a needle.

In order to provide the monitored information to the cannabis cultivators externally, the freeze dryer chamber 1 further comprises a display panel 18. Preferably, the display panel 18 is externally mounted onto the surface of the freeze dryer chamber 1, wherein the display panel 18 displays the measurements and readings taken by the plurality of sensors 16 and the plurality of probes 17. The display panel 18 may comprise any size, brand, shape etc. that is known to one of ordinary skill in the art, as long as the intents of the present invention is not altered. Further, the display panel 18 is electrically and electronically coupled to the plurality of sensors 16 and plurality of probes 17, for efficient communication and display of readings and measurements.

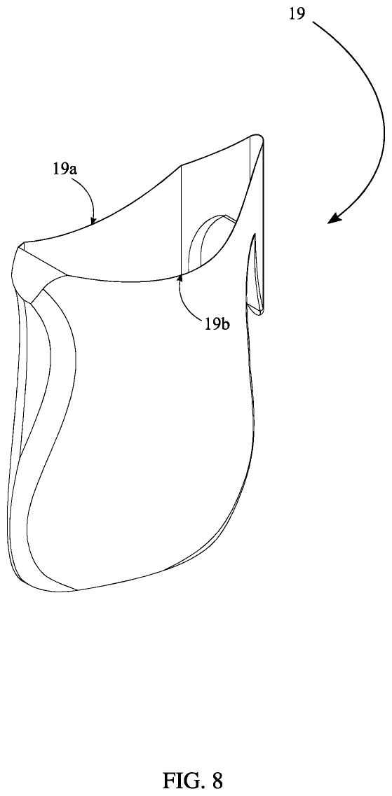

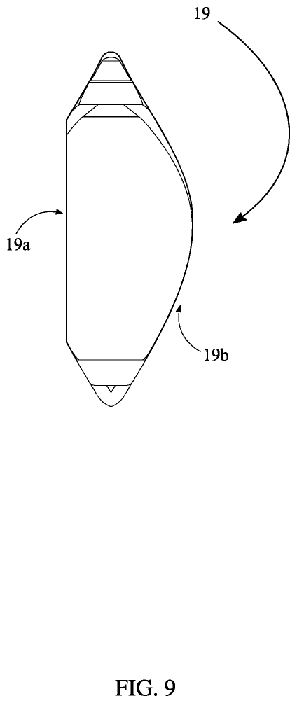

Continuing with the preferred embodiment, the present invention comprises a collection vessel 19. Preferably, the collection vessel 19 is positioned adjacent the condensation chamber 8, wherein melted ice dripping from the condensation chamber 8 is collected in the collection vessel 19. In other words, the condensation chamber 8 contains a water and/or melted ice collection vessel, underneath itself. The collection vessel 19 may comprise any material that is stainless, strong, durable, and food-grade, such as stainless steel. As seen in FIG. 8 and FIG. 9, the collection vessel 19 comprises a flat edge 19a and a curved edge 19b. The flat edge 19a is positioned opposite to the curved edge 19b across the collection vessel 19, wherein the flat edge 19a and the curved edge 19b delineate a mouth of the collection vessel 19. This is so that, the flat side 19a may be placed proximal to the rear of the inside of the freeze dryer chamber 1. In other words, the general shape of the collection vessel 19 is large enough to fit within the freeze dryer chamber 1 and be operably positioned underneath the condensation chamber 8. As seen in FIG. 8, the collection vessel 19 has a divot that makes it easier for the user to empty the contents of the collection vessel 19 collected after the freeze-drying process. Preferably, the collection vessel 19 may contain a wire rack or an encompassing hook to constrict the container within the innards of the freeze dryer chamber 1. Further, the collection vessel 19 may rest upon a shelf within the freeze dryer chamber 1, for additional stability. However, any other method known to one of ordinary skill in the art may be employed, for fastening/stabilizing the collection vessel 19.

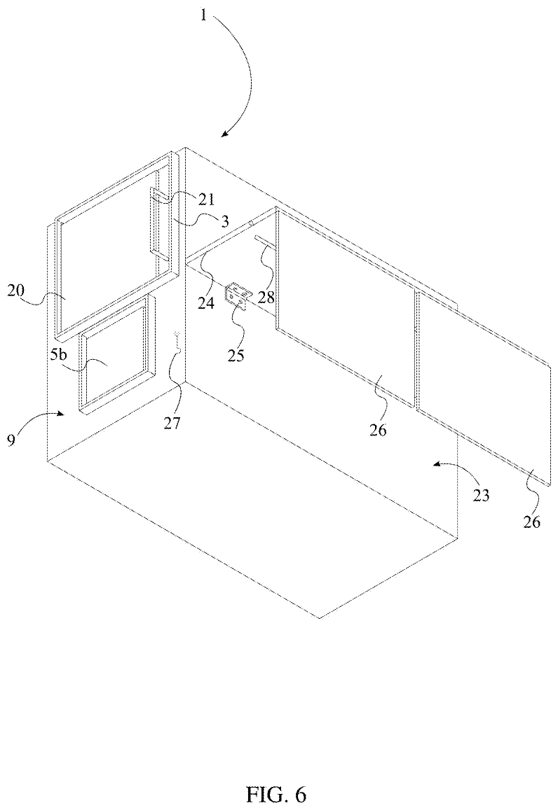

According to the preferred embodiment, the present invention comprises a writable surface 20, wherein the writable surface 20 is laterally mounted onto the blackout panel 5. Preferably, the blackout panel side 5a of the blackout panel 5 faces the glass window 4 of the front door. Similarly, as seen in FIG. 6, the condensation chamber 8 may have a blackout panel 5b, covering an observation point or access point of the condensation chamber 8. On the opposite of the blackout panel 5, the writable surface 20, such as a dry erase board or a chalk board is mounted. This enables a user to note down details of each batch of the cannabis produce inside the chamber, thereby providing means for quick and easy logging. Additionally, the blackout panel 5 may contain a clip for containing and holding a writing tool such as a dry-erase marker or chalk. Alternately, the writing surface 20 may be a separate attachment mounted on any other external surface of the freeze dryer chamber 1. According to the preferred embodiment, the present invention comprises a handle 21, wherein the handle 21 is laterally mounted onto the front door 3 and laterally offset from the writable surface 20. This is so that the handle 21 does not hinder in during the operation of the blackout panel 5. The handle 21 may be placed anywhere that is convenient for users to grasp, and the handle may be of any shape or size known to one of ordinary skill in the art.

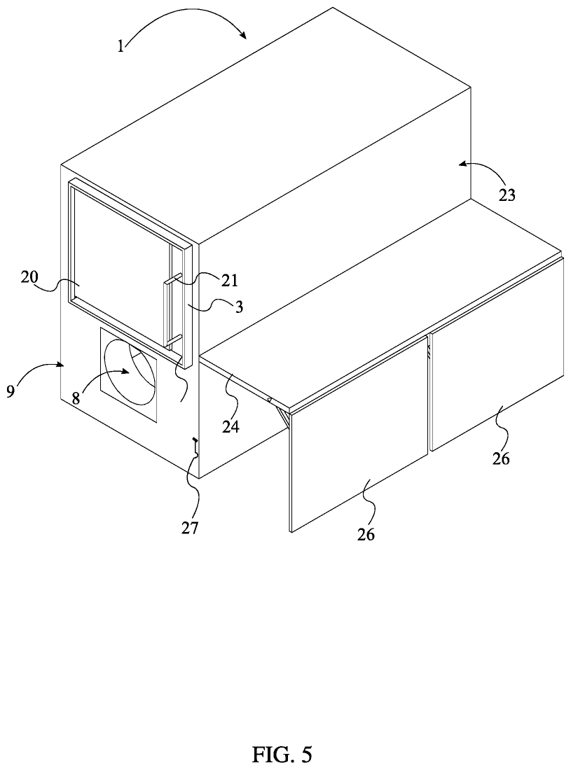

As seen in FIG. 5 through FIG. 7, the present invention comprises a collapsible worktable 22. Preferably, the collapsible worktable 22 is externally mounted onto a side surface 23 of the freeze dryer chamber 1, wherein the side surface 23 is angularly offset from the front surface 9. In other words, the collapsible worktable 22 is fixed to a free side of the freeze dryer chamber 1. The shape and orientation of the collapsible worktable 22 may change according to the shape and dimensions of the freeze dryer chamber 1. Further, the collapsible worktable 22 may be attached on any side or surface of the freeze dryer chamber 1 as well. As seen in FIG. 5 through FIG. 7, the collapsible worktable 22 comprises a tabletop 24, a plurality of piano hinges 25, and a plurality of legs 26. Preferably, the plurality of piano hinges 25 is connected between the tabletop 24 and the side surface 23, such that one end of the tabletop 24 is attached to the exterior wall of the present invention. Further, the plurality of legs 26 is hingedly attached to the tabletop 24, opposite to the plurality of piano hinges 25. As seen in FIG. 5, the plurality of legs 26 is attached to the proximal ends of the tabletop 24, and the plurality of legs 26 is foldable under the tabletop 24. According to the preferred embodiment, when the collapsible worktable 22 is in a collapsed configuration, a tabletop fastener 27 retains the tabletop 24 parallel to the side surface 23. Preferably, the tabletop fastener 27 is a hook lock or a latch lock. However, any variety of locking mechanism that is known to one of ordinary skill I the art may be employed to secure the collapsible worktable 22 in the collapsed configuration. Similarly, when the collapsible worktable 22 is in a working configuration, a plurality of leg locks 28 retain the tabletop 24 normally to the side surface 23. In other words, the plurality of leg locks 28 hold the legs normally to the tabletop 24, when the collapsible worktable 22 is in use by the user. Preferably, the leg locks 28 are located between the proximal end of the tabletop 24 and the plurality of legs 26 of the collapsible worktable 22. However, any other fasteners or fastening techniques may be employed for holding the tabletop 24 in the working configuration, as long as the intents of the present invention is not altered.

According to the preferred embodiment, the freeze dryer chamber further comprises a storage compartment 29, wherein the storage compartment 29 is externally mounted onto the external surface the freeze dryer chamber 1. Preferably, the general shape of the storage compartment 29 is no wider or taller than the side wall that the storage compartment 29 is attached to. Further, the depth of the storage compartment 29 is sufficient enough to store any general tools that users might need to prepare and inspect the cannabis produce specimens. However, the storage compartment 29 may assume any form, such as cabinets with doors, open-face cubbies, or a built-in tool cabinet, as long as the intents of the present invention is not altered. Furthermore, the storage compartment 29 is capable of containing a variety of instruments and equipment that users may or will utilize in the drying and curing process of the cannabis produce. These instruments and equipment can include, but is not limited to, the following: scissors, rulers, clippers, etc. According to the preferred embodiment, the freeze dryer chamber 1 further comprises a vacuum pump port 30, wherein the vacuum pump port 30 is externally integrated onto external surface of the freeze dryer chamber. Preferably, the vacuum pump port 30 is positioned adjacent a rear end of the freeze dryer chamber 1 but is not limited to this space. Further, the vacuum pump port 30 is operably coupled to the inner cavity 6, wherein the vacuum pump port 30 can be opened or closed to adjust the pressure within the inner cavity. Preferably, a vacuum pump is attached to the vacuum pump port 30 through a vacuum hose. The vacuum pump is capable of removing air from the freeze dryer chamber in order to decrease the air pressure within the freeze dryer chamber. Pressure decrease in the freeze dryer chamber 1 is a result of the high vacuum within the freeze dryer chamber. Thus, the vacuum pump 30 is operably coupled to the inner cavity 6, wherein the vacuum pump 30 regulates the pressure within the interior cavity.

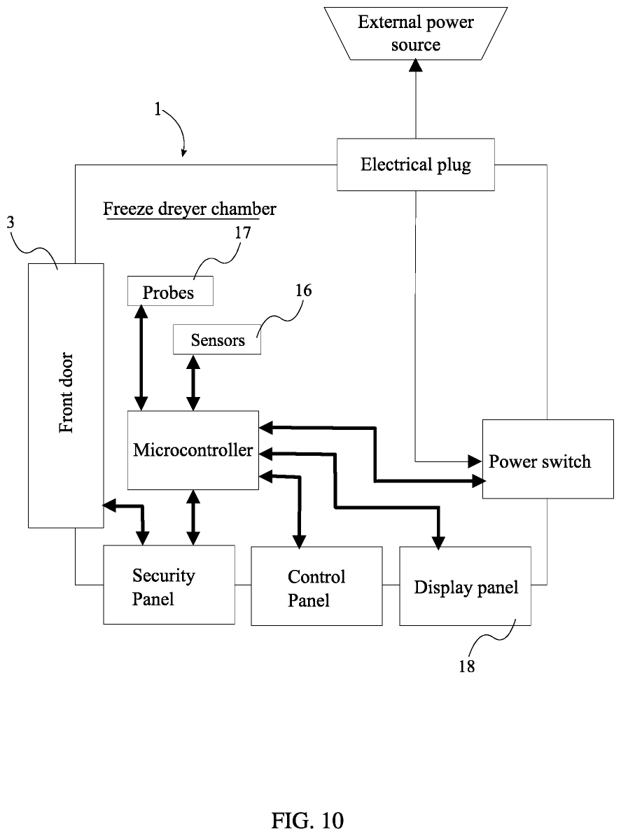

Additionally, the freeze dryer chamber comprises many other components and attachments needed for the smooth functioning of the freeze dryer machine. Such components include, but are not limited to a security panel, a control panel, a microcontroller, power plug, multiple shelves within the specimen chamber, specimen holders, holding trays, hanging weight scales etc. It should be noted that all these components may include and utilize any structure, brand, shape, components or arrangement of components that are known to one of ordinary skill in the art, as long as the objectives and intends of the present invention is not altered. As seen in FIG. 10, the microcontroller electronically communicates with the various electronic components. Further, electrical power is provided through an on/off power switch that is electrically connected to an external power source.

A preferred method of operation of the present invention comprises the following steps.

Step 1: Turn on the condensation chamber and set to the necessary temperature.

Step 2: Turn on the specimen chamber and set to the necessary temperature.

Step 3: Once the temperatures are achieved in the specimen chamber and the condensation chamber, place the cannabis plants inside the specimen chamber.

Step 4: Turn on the vacuum pump to draw all the air out of the specimen chamber and the condensation chamber and wait until the pressure reaches the required millitorr.

Step 5: Slowly increase the temperature of the specimen chamber over time, while monitoring readings of cannabis plant.

Step 6: When desired levels have reached, turn off the vacuum pump, and wait for approximately 5 seconds.

Step 7: Open vacuum release valve with the air filter to let air into the chambers.

Step 8: Turn off the specimen chamber and open the specimen chamber to remove the freeze-dried cannabis.

Step 9: Turn off the condensation chamber and open the condensation chamber, such that the collection vessel collects the ice as it melts out as ice and water.

Thus, the present invention allows cannabis cultivators to control the environmental conditions that influence the drying and curing process with the help of a single apparatus that is ergonomic, efficient and cost effective.

Although the invention has been explained in relation to its preferred embodiment, it is to be understood that many other possible modifications and variations can be made without departing from the spirit and scope of the invention as hereinafter claimed.

What is claimed is:

1. A machine for freeze drying cannabis, the machine comprising:
a freeze dryer chamber;
a vacuum release valve;
a front door;
a glass window;
a blackout panel;
the freeze dryer chamber comprising an inner cavity, a specimen chamber and a condensation chamber;
the inner cavity traversing through a front surface of the freeze dryer chamber;
the specimen chamber and the condensation chamber being mounted within the inner cavity of the freeze dry chamber;
the condensation chamber being laterally mounted onto the specimen chamber;
the vacuum release valve being integrated onto an external surface of the freeze dryer chamber, and being operably coupled to the inner cavity, wherein the vacuum release valve can be opened or closed to adjust the pressure within the inner cavity;
the front door being hingedly mounted over an opening of the inner cavity;
the glass window being laterally integrated onto the front door and positioned adjacent to the inner cavity;
the blackout panel being removably attached to the front door; and
the blackout panel being positioned adjacent the glass window, opposite to the specimen.

2. The cannabis freeze drying machine of claim 1 comprising:
a filter assembly;
the filter assembly further comprising a filter base, a rubber seal, a filter support, an air filter, and a filter cover;
the filter base being mounted onto the external surface of the freeze dryer chamber, encompassing the vacuum release valve;
the rubber seal being integrated onto the filter base;
the filter support and the filter cover being removably fastened to the filter base;
the air filter being positioned between the filter support and the filter cover; and
the filter assembly being rotatably coupled to the vacuum release valve, wherein rotating the filter assembly along with the vacuum release valve, permits opening and closing of the vacuum release valve.

3. The cannabis freeze drying machine of claim 2, wherein the filter support, the air filter, and the filter cover are flexible.

4. The cannabis freeze drying machine of claim 1 comprising:
a plurality of sensors;
a plurality of probes; and
the plurality of sensors and the plurality of probes being mounted within the freeze dryer chamber.

5. The cannabis freeze drying machine of claim 4 comprising:
the freeze dryer chamber further comprising a display panel; and
the display panel being externally mounted onto the external surface of the freeze dryer chamber, wherein the display panel displays the measurements done by the plurality of sensors and the plurality of probes.

6. The cannabis freeze drying machine of claim 5, wherein the display panel is electronically coupled to the plurality of sensors and plurality of probes.

7. The cannabis freeze drying machine of claim 1 comprising:
a collection vessel;
the collection vessel being positioned adjacent the condensation chamber, wherein melted ice dripping from the condensation chamber is collected in the collection vessel;
the collection vessel comprising a flat edge and a curved edge; and
the flat edge being positioned opposite to the curved edge across the collection vessel, wherein the flat edge and the curved edge delineate a mouth of the collection vessel.

8. The cannabis freeze drying machine of claim 1 comprising:
a writable surface;
a handle;
the writable surface being laterally mounted onto the blackout panel; and
the handle being laterally mounted onto the front door and laterally offset from the writable surface.

9. The cannabis freeze drying machine of claim 1 comprising:
a collapsible work table; and
the collapsible work table being externally mounted onto a side surface of the freeze dryer chamber, wherein the side surface being angularly offset from the front surface.

10. The cannabis freeze drying machine of claim 9 comprising:
the collapsible work table comprising, a table top, a plurality of piano hinges, a plurality of legs;
the plurality of piano hinges being connected between the table top and the side surface; and
the plurality of legs being hingedly attached to the tabletop, opposite to the plurality of piano hinges.

11. The cannabis freeze drying machine of claim 9, wherein the collapsible work table is in a collapsed configuration, a tabletop fastener retains the table top parallel to the side surface.

12. The cannabis freeze drying machine of claim 9, wherein the collapsible work table is in a working configuration, a plurality of leg locks retain the table top normally to the side surface.

13. The cannabis freeze drying machine of claim 1 comprising:
a storage compartment;
a vacuum pump port;
the storage compartment being externally mounted onto the external surface of the freeze dryer chamber;
the vacuum pump port being integrated onto the external surface of the freeze dryer chamber; and
the vacuum pump port being operably coupled to the inner cavity, wherein the vacuum pump port can be opened or closed to adjust the pressure within the inner cavity.

14. A machine for freeze drying cannabis, the machine comprising:
a freeze dryer chamber;
a vacuum release valve;
a filter assembly;
a plurality of sensors;
a plurality of probes;
a display panel;
a front door;
a glass window;
a blackout panel;
the freeze dryer chamber comprising an inner cavity, a specimen chamber and a condensation chamber;
the inner cavity traversing through a front surface of the freeze dryer chamber;
the specimen chamber and the condensation chamber being mounted within the inner cavity of the freeze dry chamber;
the condensation chamber being laterally mounted onto the specimen chamber;
the vacuum release valve being integrated onto an external surface of the freeze dryer chamber, and being operably coupled to the inner cavity, wherein the vacuum release valve can be opened or closed to adjust the pressure within the inner cavity;
the filter assembly being rotatably coupled to the vacuum release valve, wherein rotating the filter assembly along with the vacuum release valve, permits opening and closing of the vacuum release valve;
the plurality of sensors and the plurality of probes being mounted within the freeze dryer chamber;
the display panel being externally mounted onto the external surface of the freeze dryer chamber, wherein the display panel displays the measurements done by the plurality of sensors and the plurality of probes;
the front door being hingedly mounted over an opening of the inner cavity;
the glass window being laterally integrated onto the front door and positioned adjacent to the inner cavity;
the blackout panel being removably attached to the front door; and
the blackout panel being positioned adjacent the glass window, opposite to the specimen.

15. The cannabis freeze drying machine of claim 14 comprising:
the filter assembly further comprising a filter base, a rubber seal, a filter support, an air filter, and a filter cover;
the filter base being mounted onto the external surface of the freeze dryer chamber, encompassing the vacuum release valve;
the rubber seal being integrated onto the filter base;
the filter support and the filter cover being removably fastened to the filter base; and
the air filter being positioned between the filter support and the filter cover.

16. The cannabis freeze drying machine of claim 15, wherein the filter support, the air filter, and the filter cover are flexible.

17. The cannabis freeze drying machine of claim 14 comprising:
a collection vessel;
the collection vessel being positioned adjacent the condensation chamber, wherein water dripping from the condensation chamber is collected in the collection vessel;
the collection vessel comprising a flat edge and a curved edge; and
the flat edge being positioned opposite to the curved edge across the collection vessel, wherein the flat edge and the curved edge delineate a mouth of the collection vessel.

18. The cannabis freeze drying machine of claim 14 comprising:
a collapsible work table; and
the collapsible work table being externally mounted onto a side surface of the freeze dryer chamber, wherein the side surface being angularly offset from the front surface.

19. The cannabis freeze drying machine of claim 14 comprising:
a writable surface;
a handle;
the writable surface being laterally mounted onto the blackout panel; and
the handle being laterally mounted onto the front door and laterally offset from the writable surface.
